(19) United States
(12) Patent Application Publication
(10) Pub. No.: US 2025/0347889 A1
(43) Pub. Date: Nov. 13, 2025

(54) DRIVE APPARATUS AND OPTICAL APPARATUS

(71) Applicant: CANON KABUSHIKI KAISHA, Tokyo (JP)

(72) Inventor: Junya HIRANO, Tochigi (JP)

(21) Appl. No.: 19/278,172

(22) Filed: Jul. 23, 2025

(30) Foreign Application Priority Data
Feb. 6, 2023 (JP) 2023-016398

(51) Int. Cl. G02B 7/04; F16H 25/24; G03B 17/14

(52) U.S. Cl. CPC G02B 7/04; F16H 25/24; G03B 17/14; G03B 2217/002

(57) ABSTRACT

A drive apparatus includes a moving member movable in a first direction, a shaft member extending in the first direction and rotatable about an axis parallel to the first direction, and a transmission member including cogs engaged with the shaft member. The transmission member transmits a drive force in the first direction, which is generated by rotation of the shaft member, to the moving member on an inner diameter side of the cogs.

### CROSS-REFERENCE TO RELATED APPLICATIONS

This application is a Continuation of International Patent Application No. PCT/JP2024/001195, filed on Jan. 18, 2024, which claims the benefit of Japanese Patent Application No. 2023-016398, filed on Feb. 6, 2023, both of which are hereby incorporated by reference herein in their entirety.

### BACKGROUND

### Field of the Technology

The present disclosure relates to a drive apparatus configured to move a moving member.

### Description of the Related Art

Some of the above drive apparatuses rotate a leadscrew using an actuator such as a DC motor or a stepping motor, and linearly drive a driven member via a rack that is engaged with the leadscrew or another power transmission member. Japanese Patent Application Laid-Open No. 01-010470 (64-010470) discloses a structure in which a steel ball is engaged with a leadscrew, and a sliding member that holds the steel ball in a concave portion is connected to the driven member via a leaf spring. Japanese Patent Application Laid-Open No. 2001-215394 discloses a structure in which a rack is engaged with a leadscrew and connected to a driven member.

### SUMMARY

A drive apparatus according to one aspect of the present disclosure includes a moving member movable in a first direction, a shaft member extending in the first direction and rotatable about an axis parallel to the first direction, and a transmission member including cogs engaged with the shaft member. The transmission member transmits a drive force in the first direction, which is generated by rotation of the shaft member, to the moving member on an inner diameter side of the cogs. An optical apparatus having the above drive apparatus also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a perspective view and a sectional view illustrating a structure of a lens drive apparatus according to a first embodiment.

FIGS. 2A and 2B illustrate details of the lens drive apparatus according to the first embodiment.

FIGS. 3A to 3C illustrate a power transmission member according to the first embodiment.

FIGS. 4A and 4B explain the backlash and contact state when the power transmission member is driven in the first embodiment.

FIGS. 5A and 5B are other views to explain the backlash and contact state when the power transmission member is driven in the first embodiment.

FIGS. 6A to 6C explain the loss reduction principle in the first embodiment.

FIGS. 7A and 7B are a perspective view and a sectional view illustrating a structure of a lens drive apparatus according to a second embodiment.

FIG. 8 is a partially sectional view of the lens drive apparatus according to the second embodiment.

### DESCRIPTION OF THE EMBODIMENTS

Referring now to the accompanying drawings, a description will be given of embodiments according to the disclosure.

The structure disclosed in Japanese Patent Application Laid-Open No. 01-010470 generates friction loss at a contact surface between the steel ball that is engaged with the leadscrew and the sliding member. The structure disclosed in Japanese Patent Application Laid-Open No. 2001-215394 generates friction loss at a contact surface between the leadscrew and the rack. Thus, in a case where a driven member with a large mass is driven or a driven member is driven at a large acceleration, a large load or inertial force acts on the contact surface, increasing friction loss, and it is to increase the power applied to the actuator to increase the output or the size of the actuator.

### First Embodiment

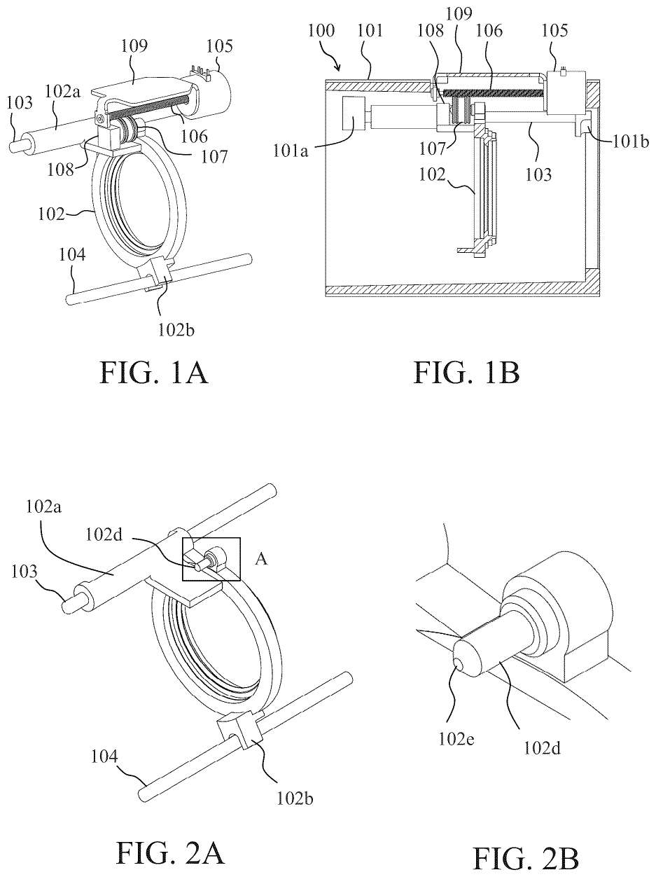

FIG. 1B illustrates a lens drive apparatus 100 according to a first embodiment. The lens drive apparatus 100 is mounted on an optical apparatus such as an interchangeable lens that can be attached to and detached from an image pickup apparatus or an image pickup apparatus with a lens barrel. FIG. 1A illustrates a part of the lens drive apparatus 100.

As illustrated in FIG. 1B, the lens drive apparatus 100 includes a fixed member 101 having a hollow cylindrical shape, a lens frame 102 as a driven member (movable member, moving member) disposed in the fixed member 101, and a main guide bar 103 and a sub guide bar 104 as guide members. The lens drive apparatus 100 further includes an actuator 105, a power transmission member (transmission member) 107, and a contact member 108. The fixed member 101 is a part of the optical apparatus.

The lens frame 102 as an optical element holding member holds a lens as an unillustrated optical element. An optical element holding member may hold an optical element other than a lens (such as an aperture stop). The main guide bar 103 and the sub guide bar 104 are fixed in the fixed member 101 by having both ends held by bar fixed portions 101a and 101b provided on the inner surface of the fixed member 101. A sleeve portion 102a of the lens frame 102 is engaged with the main guide bar 103 movably in the axial direction, and a rotation stopper 102b of the lens frame 102 is engaged with the sub guide bar 104 movably in the axial direction. The lens frame 102 is guided in the axial direction by the main guide bar 103 at the sleeve portion 102a. The rotation stopper 102b is engaged with the sub guide bar 104, and thereby prevents the lens frame 102 from rotating around the main guide bar 103.

The actuator 105 is a rotational drive source such as a stepping motor, and is fixed to the fixed member 101. A leadscrew (shaft member) 106 is provided on an output shaft of the actuator 105. The axial direction of the leadscrew 106 is parallel to the axial directions of the main guide bar 103 and the sub guide bar 104, and in the following description, these axial directions will be referred to as an optical axis direction (first direction). In the optical axis direction, the side where the actuator 105 is provided will be referred to as a rear side, and the side where the leadscrew 106 extends from the actuator 105 will be referred to as a front side. The front end of the leadscrew 106 is rotatably held by a holding plate 109 fixed to the actuator 105.

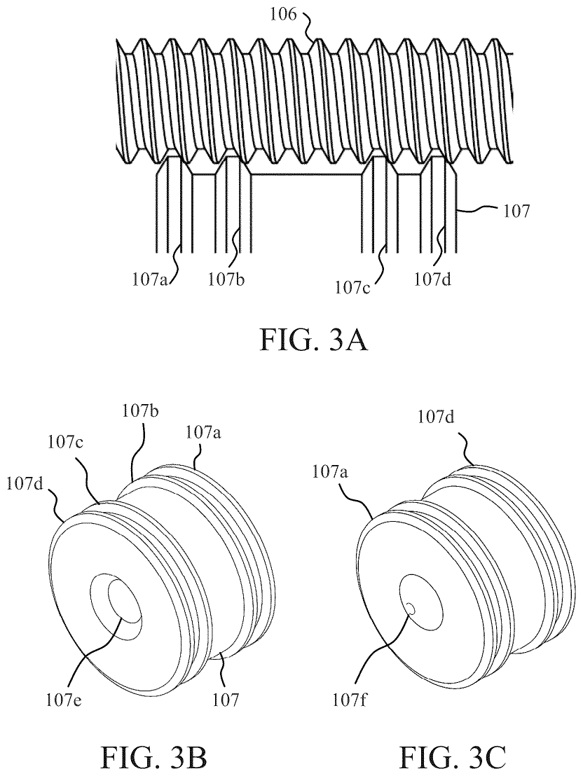

FIG. 2A illustrates the details of the shape of the lens frame 102. FIG. 2B illustrates an enlarged view of part A in FIG. 2A. The lens frame 102 includes a support shaft portion 102d that extends from the rear side to the front side. The support shaft portion 102d rotatably supports the power transmission member 107 illustrated in FIGS. 1A and 1B on its inner diameter side.

A member equivalent to the support shaft portion 102d may be manufactured as a separate member from the lens frame 102 and fixed to the lens frame 102 by bonding or other methods. In this case, another member may be interposed between the lens frame 102 and the member corresponding to the support shaft portion 102d. Even in such a case, the power transmission member 107 can be considered to be supported by the lens frame 102.

FIGS. 3A to 3C illustrate the details of the shape of the power transmission member 107. FIG. 3A illustrates a state in which a plurality of cogs of the power transmission member 107, which will be described later, are engaged with the leadscrew 106, and FIGS. 3B and 3C illustrate the power transmission member 107 when viewed from the diagonal rear side and the diagonal front side, respectively.

The power transmission member 107 has a cylindrical base shape with a plurality of cogs 107a, 107b, 107c, and 107d formed at predetermined intervals on its outer circumference (outer diameter side) in the optical axis direction. These cogs 107a to 107d extend around the entire circumference of the power transmission member 107 in the rotational direction, and are always engaged with the threads of the leadscrew 106 regardless of the rotation of the power transmission member 107.

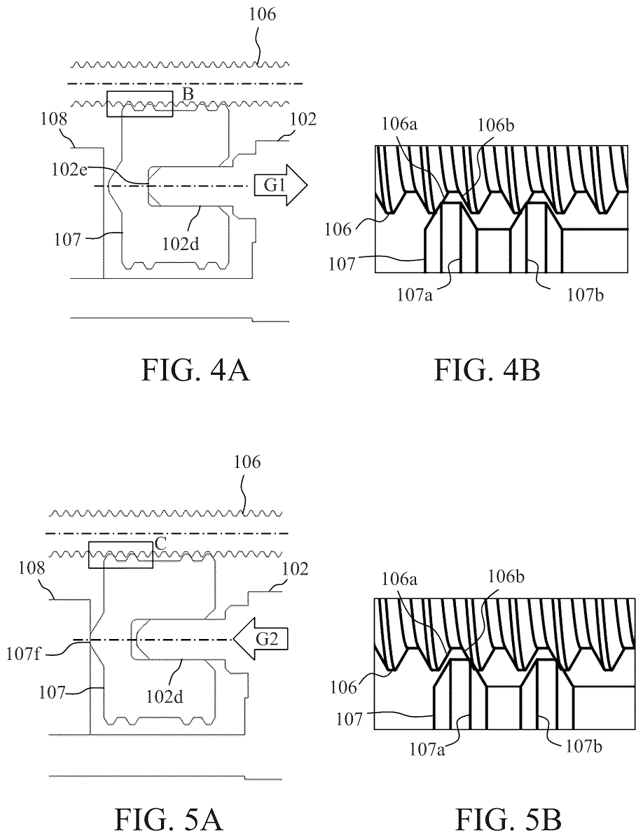

As illustrated in FIG. 3B, the power transmission member 107 is formed with a coupling portion 107e as a cylindrical concave portion with an open rear side. The support shaft portion 102d of the lens frame 102 is inserted into this coupling portion 107e (see FIG. 4A), so that the power transmission member 107 is supported rotatably around the support shaft portion 102d. The front end surface 102e of the support shaft portion 102d illustrated in FIG. 2B is a surface that can contact the front end surface within the coupling portion 107e of the power transmission member 107.

The forward movement of the power transmission member 107 relative to the lens frame 102 (removal from the support shaft portion 102d) is prevented by the contact of the front end contact portion 107f of the power transmission member 107, as illustrated in FIG. 3C, with the contact member 108 fixed to the lens frame 102, as illustrated in FIGS. 1A and 1B. The contact member 108 is manufactured as a separate member from the lens frame 102 and fixed to the lens frame 102, but even in this case, it can be considered that the power transmission member 107 contacts the lens frame 102. A portion equivalent to the contact member 108 may be provided integrally with the lens frame 102.

In the above structure, as the actuator 105 is driven and the leadscrew 106 is rotated, the rotation of the leadscrew 106 is converted into a driving force in the optical axis direction (straightforward moving direction) due to the engagement between the leadscrew 106 and the power transmission member 107. The power transmission member 107 transmits the driving force to the lens frame 102. Thereby, the lens frame 102 is driven linearly in the optical axis direction while being guided by the main guide bar 103 (and the sub guide bar 104).

The power transmission member 107 rotates relative to the lens frame 102 (support shaft portion 102d) while moving in the optical axis direction because it is engaged with the rotating leadscrew 106. Now assume that T1 is a rotational resistance (torque) generated by the coupling portion 107e of the power transmission member 107 sliding in the rotational direction relative to the support shaft portion 102d, and T2 is a rotational resistance generated by the power transmission member 107 when the first to fourth cogs 107a to 107d of the power transmission member 107 slip against the threads of the leadscrew 106. The “slip,” as used herein, does not include minute (microscopic) slippage that cannot be visually recognized. In other words, the “slip” refers to a slippage of a clear, predetermined amount (e.g., 3%) or more that can be visually recognized. Then, this embodiment satisfies the following inequality (1):

$$Rotational resistance T 1 < Rotational resistance T 2 \qquad ( 1 )$$

Inequality (1) enables the power transmission member 107 to rotate relative to the lens frame 102 while being engaged with the leadscrew 106 without slipping on the threads.

Next follows a description of a relationship between the power transmission member 107 and the leadscrew 106 in driving the lens frame 102, and a relationship between the power transmission member 107 and the lens frame 102 or the contact member 108.

FIG. 4A illustrates a state in which the backlash between the above parts is eliminated when the lens frame 102 is driven in direction G1. FIG. 4B illustrates an enlarged view of part B in FIG. 4A. In a case where the leadscrew 106 rotates in a rotational direction that drives the lens frame 102 in the direction G1, the threads appear to move in the direction G1. At this time, as illustrated in FIG. 4B, the backlash between each thread of the leadscrew 106 and the cog of the power transmission member 107 is biased on the G1 side. In other words, the threads of the leadscrew 106 contact the cogs of the power transmission member 107 from the direction G1. Moreover, the power transmission member 107 contacts the lens frame 102 (the front end surface 102e of the support shaft portion 102d), so that the backlash between them is biased. After the backlash is biased in this manner, the lens frame 102 is driven in the direction G1.

FIG. 5A illustrates a state in which the backlash between the above parts is biased when the lens frame 102 is driven in the direction G2. FIG. 5B illustrates an enlarged view of part C in FIG. 5A. In a case where the leadscrew 106 is rotated in a rotational direction that drives the lens frame 102 in the direction G2, the threads appear to move in the direction G2. At this time, as illustrated in FIG. 5B, the backlash between each thread of the leadscrew 106 and the cog of the power transmission member 107 is biased on the G2 side. In other words, the threads of the leadscrew 106 contact the cogs of the power transmission member 107 from the direction G2. Furthermore, the power transmission member 107 (front end contact portion 107f) contact the contact member 108, thereby biasing the backlash between them. After the backlash is biased in this manner, the lens frame 102 is driven in the direction G2.

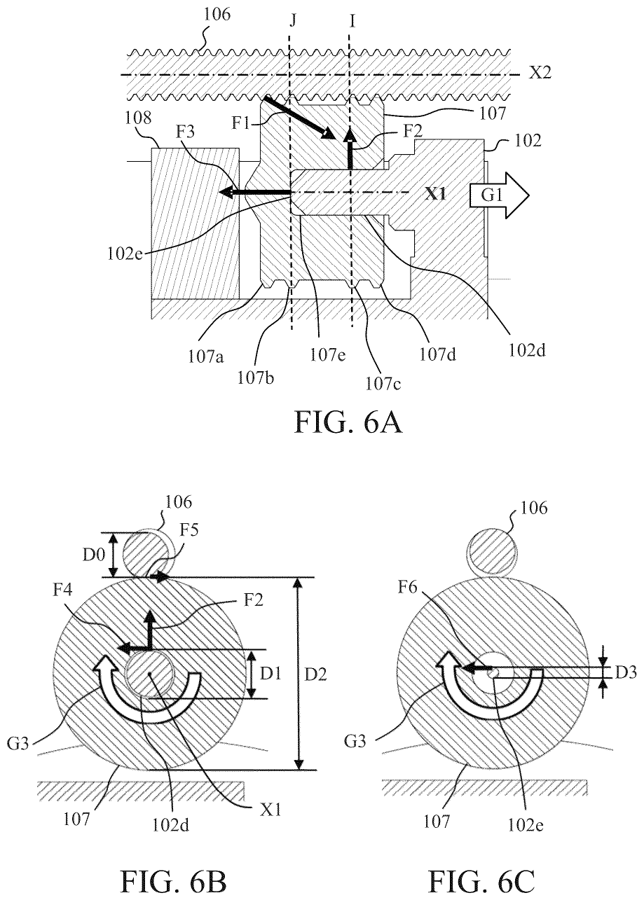

Next follows a description of the force that the power transmission member 107 receives in a case where the lens frame 102 is driven and the loss due to this force. FIG. 6A illustrates forces F1, F2, and F3 that the power transmission member 107 mainly receives in a case where the lens frame 102 is driven in the direction G1. FIG. 6B illustrates a section taken along cutting line I in FIG. 6A. FIG. 6B illustrates resistance force F4 against the rotation of the power transmission member 107 that occurs in a case where the power transmission member 107 rotates in the direction G3 while receiving the force F2, and tangential force F5 that occurs in a case where the leadscrew 106 rotates the power transmission member 107. FIG. 6C illustrates a section taken along cutting line J in FIG. 6A. FIG. 6C illustrates resistance force F6 against the rotation of the power transmission member 107 that occurs in a case where the power transmission member 107 rotates in the direction G3 while receiving the force F3. Details of the forces F1 to F3, the resistance force F4, the tangential force F5, and the resistance force F6 will be described later. As illustrated in FIGS. 6B and 6C, assume that D1 is a diameter (inner diameter) of the coupling portion 107e of the power transmission member 107. The diameter (outer diameter) of the support shaft portion 102d of the lens frame 102 is set slightly smaller than the diameter D1 of the power transmission member 107 so that the power transmission member 107 can rotate around the support shaft portion 102d. Also assume that D2 is a diameter (effective diameter) of each cog of the power transmission member 107 that meshes with the leadscrew 106, D3 is a diameter of the front end surface 102e of the support shaft portion 102d of the lens frame 102, and DO is a diameter of the leadscrew 106 (effective diameter of the thread).

The force F1 is force that the leadscrew 106, to which torque from the energized actuator 105 is input, gives to the power transmission member 107, and is generated in a direction orthogonal to the cogs (107a to 107d) of the power transmission member 107 which the threads of the leadscrew 106 contact. The force F1 increases in a case where a lens frame 102 with a larger mass is driven or in a case where the lens frame 102 is driven at a larger acceleration. F1 is a resultant force of the forces that the first to fourth cogs 107a to 107d of the power transmission member 107 receive from the leadscrew 106.

The force F2 is force that the power transmission member 107 receives from the support shaft portion 102d of the lens frame 102 in a direction orthogonal to the direction G1. The force F3 is force that the power transmission member 107 receives from the front end surface 102e of the support shaft portion 102d of the lens frame 102 in the direction opposite to the direction G1.

The rotational resistance around the rotation center axis X1 of the power transmission member 107 generated by force F2 will be discussed with reference to FIG. 6B. In the structure that satisfies inequality (1) described above, as the leadscrew 106 rotates, the power transmission member 107 rotates with almost no slippage while being engaged with the leadscrew 106. At this time, in a case where the power transmission member 107 rotates in the direction G3 while receiving the force F2, the resistance force F4 is generated between the power transmission member 107 and the lens frame 102 (support shaft portion 102d). Where T4 is a rotational resistance (torque) around rotation center axis X1 of the power transmission member 107 generated by the resistance force F4, the rotational resistance T4 is expressed by the following equation (2):

$$T 4 = F 4 \times ( D 1 / 2 ) \qquad ( 2 )$$

On the other hand, where T5 is a tangential force required for the leadscrew 106 to rotate the power transmission member 107 receiving the rotational resistance T4, the tangential force F5 is expressed by the following inequality (3):

$$F 5 > F 4 / ( D 2 / D 1 ) \qquad ( 3 )$$

From the above, where T5 is a rotational driving force required for the leadscrew 106 to rotate the power transmission member 107, the rotational driving force T5 is expressed by the following equation (4):

$$T 5 = F 5 \times ( D 0 / 2 ) \qquad ( 4 )$$

From equations (3) and (4), the rotational driving force T5 can be calculated by the following equation (5) using the resistance force F4.

$$T 5 > \{ F 4 / ( D 2 / D 1 ) \} \times ( D 0 / 2 ) \qquad ( 5 )$$

As can be viewed from equation (5), the rotational driving force T5 required for the leadscrew 106 to rotate the power transmission member 107 is reduced according to (D2/D1). This means that the resistance force F4 at the diameter D1 generated between the power transmission member 107 and the lens frame 102 is reduced by (D2/D1) at the position of the diameter D2 of the cog of the power transmission member 107. Therefore, the tangential force F5 for the leadscrew 106 to rotate the power transmission member 107 is reduced according to (D2/D1).

However, in a case where the diameter D2 increases and (D2/D1) increases, the tangential force F5 is reduced, but not only does the moment of inertia of the power transmission member 107 increase, but the size of the lens drive apparatus 100 also increases. Thus, (D2/D1) may be properly set. (D2/D1) may satisfy the following inequality (6) so that the moment of inertia of the power transmission member 107 does not increase too much and the size of the lens drive apparatus 100 does not increase.

$$1 < ( D 2 / D 1 ) < 100 \qquad ( 6 )$$

Inequality (6) may be replaced with inequality (6)′ below:

$$1 < ( D 2 / D 1 ) < 10 \qquad {( 6 )}^{′}$$

Referring now to FIGS. 6A and 6C, a description will be given of the rotational resistance around the rotation center axis X1 of the power transmission member 107 generated by the force F3. When the power transmission member 107 rotates in the direction G3 while receiving force F3, a resistance force F6 is generated between the power transmission member 107 and the lens frame 102 (front end surface 102e of the support shaft portion 102d). At this time, where T6 is a rotational resistance (torque) around the rotation center axis X1 of the power transmission member 107 generated by the resistance force F6, the rotational resistance T6 is expressed by the following equation (7):

$$T 6 = F 6 \times ( D 3 / 2 ) \qquad ( 7 )$$

At this time, by making the shape of the front end surface 102e of the support shaft portion 102d of the lens frame 102 a curved shape such as a spherical surface, the diameter D3 becomes almost zero, and the rotational resistance T6 also becomes almost zero. As a result, the rotational resistance T6 becomes a very small value. Furthermore, as described above, the resistance force F4 caused by the force F2 generated at the diameter D1 is reduced in accordance with (D2/D1) at the position of the diameter D2. Similarly, the resistance force F6 at the diameter D3 generated between the power transmission member 107 and the lens frame 102 is reduced in accordance with (D2/D3) at the position of the diameter D2 of the cogs of the power transmission member 107. Therefore, the rotational resistance T6 has almost no influence on the tangential force F5 for the leadscrew 106 to rotate the power transmission member 107, and can be ignored.

The front end contact portion 107f of the power transmission member 107 that contacts the contact member 108 may have a curved shape such as a spherical surface.

A description will now be given of a difference in rotational resistance between the structure of this embodiment and the conventional structures (Japanese Patent Application Laid-Open Nos. 01-010470 and 2001-215394). In the conventional structure that does not use the power transmission member 107 according to this embodiment, the steel ball or rack that is the power transmission member is directly engaged with the leadscrew. Therefore, a resistance force such as friction is generated against force equivalent to the force F1 illustrated in FIG. 6A, and this resistance force becomes the tangential force of the leadscrew required to rotate the power transmission member.

On the other hand, in this embodiment, the leadscrew 106 and the power transmission member 107 rotate relative to each other with almost no slippage, so no resistance force such as friction is generated due to the force F1, and instead the resistance force F4 such as friction is generated due to the force F2. As a result, the tangential force F5 of the leadscrew 106 to rotate the power transmission member 107 is reduced by reducing the resistance forces F4 and F6 according to (F1/F2) and (D2/D1). Therefore, in the structure using the power transmission member 107 as in this embodiment, the load on the leadscrew 106 (that is, the actuator 105) can be reduced according to (F1/F2) and (D2/D1). In other words, the loss in transmitting the driving force from the leadscrew 106 to the power transmission member 107 can be reduced. Therefore, the driving force applied to the lens frame 102 can be increased relative to the torque input transmitted from the actuator 105 to the leadscrew 106, and the lens drive apparatus 100 has high driving efficiency.

Although the lens frame 102 is driven in the direction G1, this is similarly applicable to a case where the lens frame 102 is driven in the opposite direction G2.

For example, in the conventional structure in which the power transmission member does not rotate, the leadscrew diameter is 1.6 mm, an angle between the cog of the power transmission member (rack, etc.) and the thread of the leadscrew is 60°, a coefficient of sliding friction between the cogs and the thread is 0.1, and the force corresponding to F1 is 1 N. In this case, the load torque of the leadscrew is 0.08 mmN.

In contrast, in this embodiment, D2 is 6 mm, D1 is 1 mm, the leadscrew diameter is 1.6 mm, the angle between each cog of the power transmission member 107 and the thread of the leadscrew 106 is 60°, the coefficient of sliding friction between the support shaft portion 102d and the coupling portion 107e is 0.1, and F1 is 1 N. In this case, the load torque of the leadscrew 106 is 0.007 mmN. Thus, in this embodiment, the load torque of the leadscrew 106 can be significantly reduced compared to that of the conventional structure.

### Second Embodiment

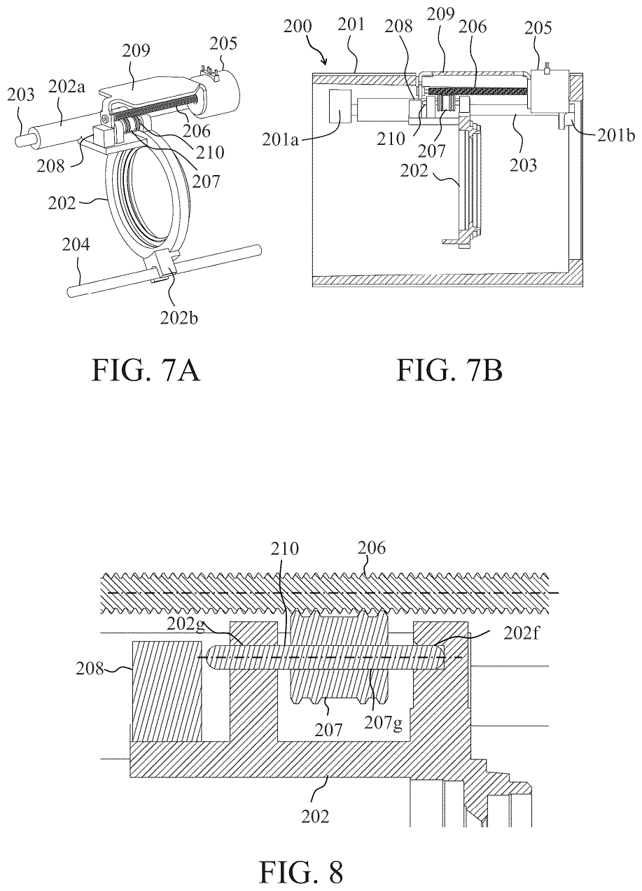

FIG. 7B illustrates a lens drive apparatus 200 according to a second embodiment. FIG. 7A illustrates a part of the lens drive apparatus 200. The components of this embodiment that are common or similar to those of the first embodiment will be designated by the same names as those in the first embodiment.

As illustrated in FIG. 7B, the lens drive apparatus 200 includes a fixed member 201 having a hollow cylindrical shape, a lens frame 202 as a driven member disposed in the fixed member 201, and a main guide bar 203 and a sub guide bar 204 as guide members. The lens drive apparatus 200 further includes an actuator 205, a power transmission member 207, and a contact member 208.

The lens frame 202 holds a lens (not illustrated). The main guide bar 203 and the sub guide bar 204 are fixed in the fixed member 201 at both ends held by fixed portions 201a and 201b provided on the inner surface of the fixed member 201.

A sleeve portion 202a of the lens frame 202 is engaged with the main guide bar 203 movably in the optical axis direction, and a rotation stopper 202b of the lens frame 202 is engaged with the sub guide bar 204 movably in the optical axis direction. The lens frame 202 is guided in the optical axis direction by the main guide bar 203 at the sleeve portion 202a. The rotation stopper 202b is engaged with the sub guide bar 204, and thereby prevents the lens frame 202 from rotating around the main guide bar 203.

The actuator 205 is a rotational drive source such as a stepping motor, and is fixed to the fixed member 201. A leadscrew 206 is provided on an output shaft of the actuator 205. The axial directions of the leadscrew 206, the main guide bar 203, and the sub guide bar 204 are parallel to the optical axis direction. The front end of the leadscrew 206 is rotatably held by a holding plate 209 fixed to the actuator 205.

FIG. 8 illustrates a structure for holding the power transmission member 207 in the lens frame 202. The power transmission member 207 includes first to fourth cogs, similarly to the power transmission member 107 of the first embodiment. The diameter of each cog is D2, which is the same as that in the first embodiment. A through-hole 207g extending in the optical axis direction is formed at the center of the power transmission member 207, and a coupling shaft 210 is inserted into the through-hole 207g and fixed integrally to the power transmission member 207. The diameter of the coupling shaft 210 is the same as the diameter D1 of the coupling portion 107e in the first embodiment. The coupling shaft 210 inserted into the through-hole 207g may be fixed to the power transmission member 207 by any method that can be used, such as press-fitting or bonding. The power transmission member 207 and the coupling shaft 210 fixed thereto can be collectively regarded as the power transmission member.

The lens frame 202 includes a holding concave portion 202f and a holding hole portion 202g for rotatably holding the rear end and front end of the coupling shaft 210 as shaft portions each protruding from the power transmission member 207.

This embodiment also satisfies inequality (1) described in the first embodiment. Inequality (6) may be satisfied.

In the structure of this embodiment, the power transmission member 207 (coupling shaft 210) is rotatably supported on both sides by the lens frame 202, so that the structure is more rigid than that of the first embodiment and the lens frame 202 with a larger mass can be driven. In this embodiment, where D4 is a diameter of the coupling shaft 210 and D5 is a diameter of the power transmission member 207, the resistance force acting between the leadscrew 206 and the power transmission member 207 can be reduced in accordance with (D5/D4). Thereby, the loss can be reduced in transmitting the driving force from the leadscrew 206 to the power transmission member 207. Therefore, the driving force applied to the lens frame 202 can be increased for the torque input transmitted from the actuator 205 to the leadscrew 206, and the lens drive apparatus 200 has high driving efficiency.

In the above embodiments, a guide bar is used as a guide member for the driven member, but a guide member other than a guide bar may be used. As a structure for rotatably supporting the power transmission member, a structure other than support by a support shaft or a connecting shaft as in the above embodiments may be used. A structure for preventing the power transmission member from moving in a straightforward moving direction relative to the driven member may use a structure other than contact against the contact member illustrated in the first embodiment (for example, biasing in a direction that prevents movement using a spring). The shape of the engagement portion between the leadscrew and the power transmission member may have a shape other than the above shape.

In each of the above embodiments, the lens frame that holds the lens is described as the driven member, but the driven member may be something other than the lens frame. A structure similar to that of the lens drive apparatus in each embodiment may be applied to a variety of drive apparatuses that drive a variety of driven members other than lenses.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can reduce loss in a case where a driven member is driven by a leadscrew through a power transmission member engaged with the leadscrew.

What is claimed is:

1. A drive apparatus comprising:
a moving member movable in a first direction;
a shaft member extending in the first direction and rotatable about an axis parallel to the first direction; and
a transmission member including cogs engaged with the shaft member,
wherein the transmission member transmits a drive force in the first direction, which is generated by rotation of the shaft member, to the moving member on an inner diameter side of the cogs.

2. The drive apparatus according to claim 1, wherein the transmission member is rotatably supported by the moving member so that a rotational resistance received by the transmission member from a part rotatably supported by the moving member when the shaft member rotates is smaller than a rotational resistance that causes slippage at an engagement portion between the transmission member and the shaft member.

3. The drive apparatus according to claim 1, wherein the following inequality is satisfied:
$$1 < ( D 2 / D 1 ) < 100$$
where D1 is a diameter of a part of the transmission member that is rotatably supported relative to the moving member, and D2 is a diameter of a part of the transmission member that is engaged with the shaft member.

4. The drive apparatus according to claim 1, wherein the transmission member moves in the first direction while rotating along with the rotation of the shaft member.

5. The drive apparatus according to claim 1, wherein the transmission member is rotatably supported by the moving member at a concave portion or shaft portion provided on the inner diameter side.

6. The drive apparatus according to claim 1, wherein the transmission member is rotatably supported by the moving member.

7. The drive apparatus according to claim 1, wherein the transmission member has a part that contacts the moving member in the first direction, and has a curved shape.

8. An optical apparatus comprising:
the drive apparatus according to claim 1; and
a holding member as the moving member configured to hold an optical element.
